(19) United States
(12) Patent Application Publication
(10) Pub. No.: US 2013/0212381 A1
(43) Pub. Date: Aug. 15, 2013

(54) SYSTEM AND METHOD FOR CONTROLLING AUTHORIZED ACCESS TO A STRUCTURED TESTING PROCEDURE ON A MEDICAL DEVICE

(71) Applicants: Steven A. Bousamra, Carmel, IN (US); Douglas M. Charboneau, Indianapolis, IN (US); Daniel J. DiSalvo, Indianapolis, IN (US); Alan M. Greenburg, Indianapolis, IN (US); Ulrich Porsch, Weinheim (DE); John F. Price, McCordsville, IN (US); Raymond A. Strickland, Indianapolis, IN (US); William T. Tucek, Fishers, IN (US); Stefan Weinert, Pendleton, IN (US)

(72) Inventors: Steven A. Bousamra, Carmel, IN (US); Douglas M. Charboneau, Indianapolis, IN (US); Daniel J. DiSalvo, Indianapolis, IN (US); Alan M. Greenburg, Indianapolis, IN (US); Ulrich Porsch, Weinheim (DE); John F. Price, McCordsville, IN (US); Raymond A. Strickland, Indianapolis, IN (US); William T. Tucek, Fishers, IN (US); Stefan Weinert, Pendleton, IN (US)

(73) Assignee: ROCHE DIAGNOSTICS OPERATIONS, INC., Indianapolis, IN (US)

(21) Appl. No.: 13/397,241

(22) Filed: Feb. 15, 2012

(51) Int. Cl. G06F 21/22

(52) U.S. Cl. 713/156

(57) ABSTRACT

Methods and systems for authorizing access to a medical device are disclosed. The methods and systems use authorization certificates to allow and prevent access to one or more operations of the medical device. The methods and systems also allow the tracking of changes made to the medical device by an authorized user.

### TECHNICAL FIELD

Embodiments of the present invention relate generally to devices collecting physiological information, and particularly to a system and method for controlling authorized access to a structured testing procedure or protocol running on a portable, hand-held collection device.

### BACKGROUND

A disease which is long lasting or which reoccurs often is defined typically as a chronic disease. Known chronic diseases include, among others, depression, alcoholism, asthma, autoimmune diseases (e.g. ulcerative colitis, lupus erythematosus), osteoporosis, cancer, and diabetes mellitus. Such chronic diseases require chronic care management for effective long-term treatment. After an initial diagnosis, one of the functions of chronic care management is then to optimize a patient's therapy of the chronic disease.

In the example of diabetes mellitus, which is characterized by hyperglycemia resulting from inadequate insulin secretion, insulin action, or both, it is known that diabetes manifests itself differently in each person because of each person's unique physiology that interacts with variable health and lifestyle factors such as diet, weight, stress, illness, sleep, exercise, and medication intake. Biomarkers are biologically derived indicators of biological or pathogenic processes, pharmacologic responses, events or conditions (e.g., aging, disease or illness risk, presence or progression, etc.). For example, a biomarker can be an objective measurement of a variable related to a disease, which may serve as an indicator or predictor of that disease. In the case of diabetes mellitus, such biomarkers include measured values for glucose, lipids, triglycerides, and the like. A biomarker can also be a set of parameters from which to infer the presence or risk of a disease, rather than a measured value of the disease itself. When properly collected and evaluated, biomarkers can provide useful information related to a medical question about the patient, as well as be used as part of a medical assessment, as a medical control, and/or for medical optimization.

For diabetes, clinicians generally treat diabetic patients according to published therapeutic guidelines such as, for example, Joslin Diabetes Center & Joslin Clinic, Clinical Guideline for Pharmacological Management of Type 2 Diabetes (2007) and Joslin Diabetes Center & Joslin Clinic, Clinical Guideline for Adults with Diabetes (2008). The guidelines may specify a desired biomarker value, e.g., a fasting blood glucose value of less than 100 mg/dl, or the clinician can specify a desired biomarker value based on the clinician's training and experience in treating patients with diabetes. However, such guidelines do not specify biomarker collection procedures for parameter adjustments to support specific therapies used in optimizing a diabetic patient's therapy. Subsequently, diabetic patients often must measure their glucose levels with little structure for collection and with little regard to lifestyle factors. Such unstructured collections of glucose levels can result in some biomarker measurements lacking interpretative context, thereby reducing the value of such measurements to clinicians and other such health care providers that help patients to manage their disease.

A patient with a chronic disease may be asked by different clinicians at various times to perform a number of collections in an effort to diagnose a chronic disease or to optimize therapy. Some collection devices have been proposed that attempt to facilitate these collections as part of a structured testing procedure. However, prior art collection devices that perform structured testing procedures provide either minimal security or no security at all to the structured testing procedures on the collection devices.

Patients and clinicians may view the prior art collection devices as being difficult to configure, since clinicians are unable to tailor a user's control over the testing procedures to the needs of an individual user. For example, collection devices that utilize only minimal authorization schemes lack the ability to hide one or more testing procedures on the device from a patient. This requires a clinician to take additional steps to ensure that the device is running the proper testing procedures, or to train a user how to use only certain functions of the device.

In addition, collection devices that utilize only minimal authorization schemes also lack the ability to distinguish between the access privileges of the various users of the device. For example, a technician from the device manufacturer may need the ability to update the device's firmware and software, a clinician may need the ability to configure a structured testing procedure on the device, and a patient may need the ability to interrupt a running testing procedure. Collection devices that lack robust authorization schemes are unable to ensure that the different types of users of a device are only able to access only functions of the device that are necessary for their respective roles.

In addition, collection devices that utilize only minimal authorization schemes also lack the ability to track pertinent information about the device itself. For example, collection devices that lack the ability to set up different authorization roles for the users of a device are also unable to track changes to these authorizations. Such devices would not only be unable to allow a clinician to authorize a patient to access only specific functions of the device, but would also be unable to track the granting of these authorizations. Tracking such authorization changes would allow users to determine which clinician authorized the patient to use a specific testing procedure on the device, when the authorization was made, and if any deviations from the standard testing procedure were also authorized at that time.

### SUMMARY

It is against the above background that embodiments of the present invention present a system and method for controlling authorized access to a structured testing procedure or protocol running on a portable, hand-held collection device. Embodiments of the present invention can be implemented on various collection devices, such as a blood glucose measuring device (meter) that has the capability to accept and run thereon one or more testing procedures and associated meter-executable scripts according to the present invention. These testing procedures in one embodiment can have associated authorizations, thereby allowing an administrator to control user access to the functions of the device.

In one embodiment, a method for authorizing access to a medical device is disclosed. The method includes storing, within a memory of the medical device, a structured testing procedure. The method also includes receiving, at an interface of the medical device, an authorization certificate associated with the operation in response to a request received from a user interface device operated by a certificate administrator. The method further includes storing data indicative of the identity of the certificate administrator, the medical device, and the structured testing procedure. The method yet further includes executing program instructions within a processor of the medical device to perform an operation of the structured testing procedure only if the authorization certificate allows the operation to be performed.

In another embodiment, a blood glucose meter is disclosed. The blood glucose meter includes a display, a memory, and a processor operably connected to the memory and the display. The blood glucose meter also includes program instructions that, when executed by the processor, cause the processor to determine if an authorization certificate associated with an operation of a structured testing procedure allows the operation to be performed, to perform an operation of a structured testing procedure based on the determination, to receive the authorization certificate in response to a request from a certificate administrator, and to cause data indicative of the identity of the certificate administrator, the glucose meter, and the structured testing procedure to be stored.

In still another embodiment, a system for determining a dosage of a medicament is disclosed. The system includes a collection device that determines the dosage using a structured testing procedure, wherein an operation of the structured testing procedure is performed only if an authorization certificate associated with the testing procedure allows the operation to be performed. The system also includes a certificate administration computing device that provides the authorization certificate to the collection device in response to receiving a request from a certificate administrator, wherein the certificate administration computing device further stores data indicative of the identity of the certificate administrator, the collection device, and the structured testing procedure.

These and other advantages and features of the invention disclosed herein, will be made more apparent from the description, drawings and claims that follow.

### BRIEF DESCRIPTION OF THE DRAWINGS

The following detailed description of the embodiments of the present invention can be best understood when read in conjunction with the following drawings, where like structure is indicated with like reference numerals.

FIG. 1 is a diagram showing a chronic care management system for a diabetes patient and a clinician along with others having an interest in the chronic care management of the patient, according to an embodiment of the present invention.

FIG. 2 is a diagram showing embodiments of a system suitable for implementing a structured collection, according to an embodiment of the present invention.

FIG. 3 shows a method for authorizing access to a medical device, according to an embodiment of the present invention.

FIG. 4 shows a method for using authorization certificates to control access to a medical device, according to an embodiment of the present invention.

FIG. 5 show a method of authorizing a structured testing procedure, according to a use case embodiment of the present invention.

### DETAILED DESCRIPTION

The present invention will be described below relative to various illustrative embodiments. Those skilled in the art will appreciate that the present invention may be implemented in a number of different applications and embodiments and is not specifically limited in its application to the particular embodiments depicted herein. In particular, the present invention will be discussed below in connection with diabetes management using a collection device, although those of ordinary skill will recognize that the present invention could be modified to be used with other types of medical devices for the treatment of diabetes, such as an insulin pump.

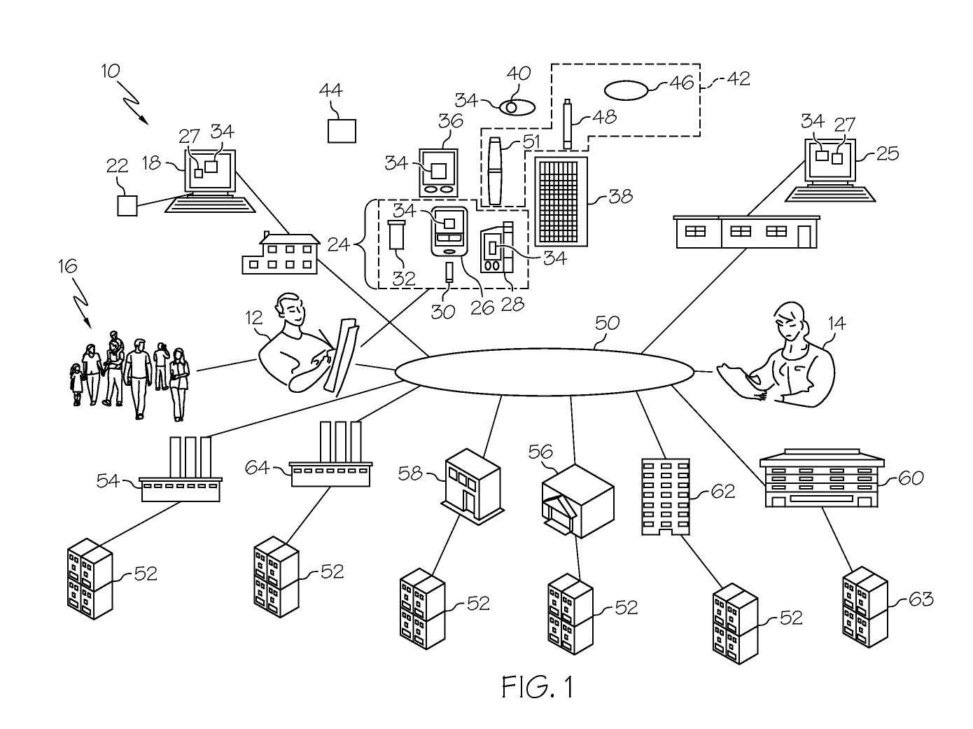

FIG. 1 shows a chronic care management system 10 for a diabetes patient 12 and a clinician 14 along with others 16 having an interest in the chronic care management of the patient 12. Patient 12, having dysglycemia, may include persons with a metabolic syndrome, pre-diabetes, type 1 diabetes, type 2 diabetes, and gestational diabetes. The others 16 with an interest in the patient's care may include family members, friends, support groups, and religious organizations all of which can influence the patient's conformance with therapy. The patient 12 may have access to a patient computer 18, such as a home computer, which can connect to a network 50 (wired or wireless), such as the internet, cellular network, etc., and coupled to a dongle, docking station, or device reader 22 for communicating with an external portable device, such as a portable collection device 24. An example of a device reader is shown in the manual “Accu-Chek® Smart Pix Device Reader User's Manual” (2008) available from Roche Diagnostics.

The collection device 24 can be essentially any portable electronic device that can function as an acquisition mechanism for determining and storing digitally biomarker values according to a structured testing procedure, and which can function to use the authorization scheme and the method of the present invention. Greater details regarding various illustrated embodiments of the authorization scheme are provided hereafter in later sections. In one embodiment, the collection device 24 can be a self-monitoring blood glucose meter 26 or a continuous glucose monitor 28. An example of a blood glucose meter is the Accu-Chek® Active meter, and the Accu-Chek® Aviva meter described in the booklet “Accu-Chek® Aviva Blood Glucose Meter Owner's Booklet” (2007), portions of which are disclosed in U.S. Pat. No. 6,645,368 B1 entitled “Meter and method of using the meter for determining the concentration of a component of a fluid” assigned to Roche Diagnostics Operations, Inc., which is hereby incorporated by reference. An example of a continuous glucose monitor is shown in U.S. Pat. No. 7,389,133 “Method and device for continuous monitoring of the concentration of an analyte” (Jun. 17, 2008), assigned to Roche Diagnostics Operations, Inc., which is also hereby incorporated by reference.

In addition to the collection device 24, the patient 12 can use a variety of products to manage his or her diabetes including: test strips 30 carried in a vial 32 for use in the collection device 24, software 34 which can operate on the patient computer 18, the collection device 24, a handheld computing device 36, such as a laptop computer, a personal digital assistant, and/or a mobile phone, and paper tools 38. Software 34 can be pre-loaded or provided either via a computer readable medium 40 or over the network 50 and loaded for operation on the patient computer 18, the collection device 24, the clinician computer/office workstation 25, and the handheld computing device 36, if desired. In still other embodiments, the software 34 can also be integrated into the device reader 22 that is coupled to the computer (e.g., computers 18 or 25) for operation thereon, or accessed remotely through the network 50, such as from a server 52.

The patient 12 can also use, for certain diabetes therapies, additional therapy devices 42 and other devices 44. Additionally, therapy devices 42 can include devices such as an ambulatory infusion pump 46, an insulin pen 48, and a lancing device 51. An example of an ambulatory insulin pump 46 may include, but is not limited to, the Accu-Chek® Spirit pump described in the manual “Accu-Chek® Spirit Insulin Pump System Pump User Guide” (2007), available from Roche Diabetes Care. The other devices 44 can be medical devices that provide patient data such as blood pressure, fitness devices that provide patient data such as exercise information, and elder care devices that provide notification to care givers. The other devices 44 can be configured to communicate with each other according to standards planned by Continua® Health Alliance.

The clinician 14 may be any type of health care provider such as a nurse, nurse practitioner, physician, physician assistant, endocrinologist, or other such health care provider. The clinician 14 typically has access to a clinician computer 25, such as a clinician office computer, which can also be provided with the software 34. A healthcare record system 27, such as Microsoft® HealthVault™ and Google™ Health, may also be used by the patient 12 and the clinician 14 on computers 18, 25 to exchange information via the network 50 or via other network means (LANs, WANs, VPNs, etc.), and to store information such as collection data from the collection device 24 to an electronic medical record of the patient which can be provided to and from computer 18, 25 and/or server 52.

Most patients 12 and clinicians 14 can interact over the network 50 with each other and with others having computers/servers 52. Such others can include the patient's employer 54, a third party payer 56, such as an insurance company who pays some or all of the patient's healthcare expenses, a pharmacy 58 that dispenses certain diabetic consumable items, a hospital 60, a government agency 62, which can also be a payer, and companies 64 providing healthcare products and services for detection, prevention, diagnosis and treatment of diseases. The patient 12 can also grant permissions to access the patient's electronic health record to others, such as the employer 54, the payer 56, the pharmacy 58, government agencies 62, and other entities (e.g., a hospital, a nursing care facility, etc.) via the healthcare record system 27, which can reside on the clinician computer 25 and/or one or more servers 52.

Patient 12 and clinician 14 can also interact over the network 50 with device manufacturer 60 having computers/servers 63. Device manufacturer 60 manufactures collection device 24 and/or therapy devices 42 and can provide software, software updates, firmware updates, configuration settings, security settings, alerts, and other information to computers 18 and 25, to collection device 24, or to therapy devices 42. In some embodiments, device manufacturer 60 provides the software, updates, settings, etc., automatically using server 63 and without a prior request from the electronic devices used by patient 12 or clinician 14. In other embodiments, device manufacturer 60 provides the software, updates, settings, etc. in response to a request received at server 63 via network 50.

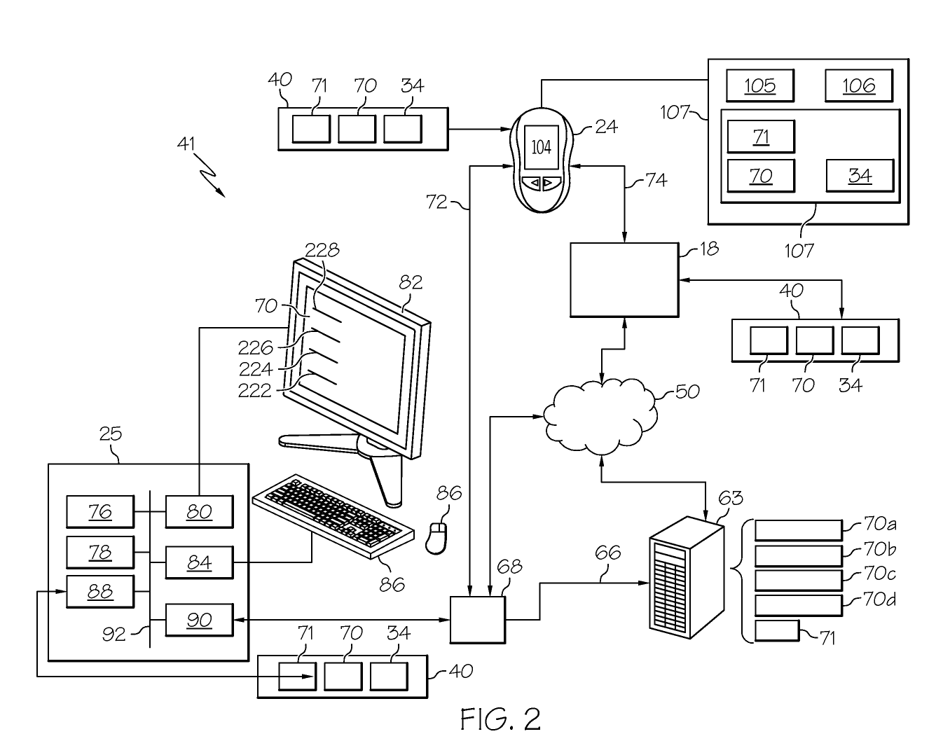

Referring now to FIG. 2, a system 41 is shown that is suitable for implementing a structured collection according to an embodiment of the present invention, which in another embodiment can be a part of the chronic care management system 10 and communicate with such components, e.g., via conventional wired or wireless communication means. The system 41 can include the clinician computer 25 that is in communication with the server 63, as well as the collection device 24. Communications between the clinician computer 25 and the server 63 can be facilitated via a communication link to the network 50, to a private network 66, or combinations thereof. The private network 66 can be a local area network or a wide area network (wired or wireless) connected to the network 50 via a network device 68 such as a (web) server, router, modem, hub, and the likes.

In one embodiment, the server 63 can be a central repository for a plurality of unique structured testing procedures (or protocols) 70a, 70b for use with collection device 24. The structured testing procedures 70a, 70b typically include the schedule and conditions under which information pertaining to one or more biomarkers is to be collected. Any number of testing procedures may be used by collection device 24. For example, any of the structured collection procedures disclosed in U.S. application Ser. No. 12/643,415 (U.S. Patent Application Publication No. 2010/0218132), the entirety of which is hereby incorporated by reference, may be used as the structured testing procedures 70a, 70b. The term “structured testing procedure” as used herein has substantially the same meaning as the “structured collection procedure” referred to in U.S. application Ser. No. 12/643,415 (U.S. Patent Application Publication No. 2010/0218132). Server 63 can also be a central repository for software updates 70c (e.g., application updates, operating system updates, firmware updates, etc.), for settings 70d (e.g., configuration settings, parameters, etc.), and for security settings 71.

In one embodiment, one or more of the plurality of structured testing procedures 70a, 70b, on the server 63 can be provided over the network 50, such as through a secure web interface 55 implemented on the patient computer 18, the clinician computer 25, and/or the collection device 24. In another embodiment, the clinician computer 25 can serve as the interface (wired or wireless) 72 between the server 63 and the collection device 24. In still another embodiment, the structured testing procedures 70a, 70b, software updates 70c, settings 70d, security settings 71, as well as software 34, may be provided on a computer readable medium 40 and loaded directed on the patient computer 18, the clinician computer 25, and/or the collection device 24. In still another embodiment, the structured testing procedures 70a, 70b, software updates 70c, settings 70d, and security settings 71 may be provided pre-loaded (embedded) in memory of the collection device 24. In still other embodiments, new/updated/modified structured testing procedures 70a, 70b, software updates 70c, settings 70d, security settings 71, may be sent between the patient computer 18, the clinician computer 25, the server 63 and/or the collection device 24 via the network 50, the private network 66, via a direct device connection (wired or wireless) 74, or combinations thereof. Accordingly, in one embodiment the external devices, e.g., computers 18 and 25, can be used to establish a communication link 72, 74 between the collection device 24 and still further electronic devices such as other remote personal computers (PCs), and/or servers through the network 50, which may include the Internet and/or other communication networks (e.g., LANs, WANs, VPNs, etc.), such as private network 66. In some embodiments, network 50 may be a direct connection between devices (e.g., via a serial connection, RS-232 connection, USB connection, etc.).

The clinician computer 25, as a conventional personal computer/workstation, can include a processor 76 which executes programs, such as software 34, which may be stored on memory 78 and/or non-transitory computer readable medium 40. Memory 78 can include system memory (RAM, ROM, EEPROM, etc.), storage memory, such as hard drives and/or flash memory (internal or external), as well as other types of non-transitory memory. The clinician computer 25 can also include a display driver 80 to interface a display 82 with the processor 76, input/output connections 84 for connecting user interface devices 86, such as a keyboard and mouse (wired or wireless), and computer readable drives 88 for portable memory and discs, such as computer readable medium 40. The clinician computer 25 can further include communication interfaces 90 for connections to the network 50 and other devices, such as collection device 24 (wired or wireless), and a bus interface 92 for connecting the above mentioned electronic components to the processor 76.

Collection device 24 can include display 104, processor 105, interface 106, and memory 107. Processor 105 executes computer-executable program instructions stored in, for example, a memory 107. Such processors may comprise a microprocessor, a programmable logic controller (PLC), an ASIC, and state machines. Such processors comprise, or may be in communication with, media, for example non-transitory computer-readable media 40, which stores and communicates instructions that, when executed by processor 105, cause processor 105 to perform the acts/functions described herein. Processor 105 can be any of a number of computer processors, such as processors from Intel Corporation of Santa Clara, Calif. and Motorola Corporation of Schaumburg, Ill. Embodiments of computer-readable media include, but are not limited to, an electronic, optical, magnetic, or other storage or transmission device capable of providing a processor, such as the processor 105 with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions, such as, e.g., memory 107. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript, and implemented in assembly or machine language, if desired. In any case, the language may be a compiled or interpreted language.

Interfaces 106 may include any number of internal and external interfaces for collection device 24. For example, interfaces 106 may include one or more user interfaces configured to receive input from a user input device (e.g., a keypad, a microphone, a touch-screen, or any other form of electronic input device) and to provide data from processor 105 to an output device (e.g., a speaker, electronics that cause the collection device to vibrate, a display, or any other form of electronic output device). For example, interfaces 106 may include a display interface to provide data from processor 105 to display 104. Interfaces 106 may further include one or more network interfaces to support communications link 74. For example interfaces 106 may include an Ethernet port and a wireless transmitter/receiver to communicate via link 74.

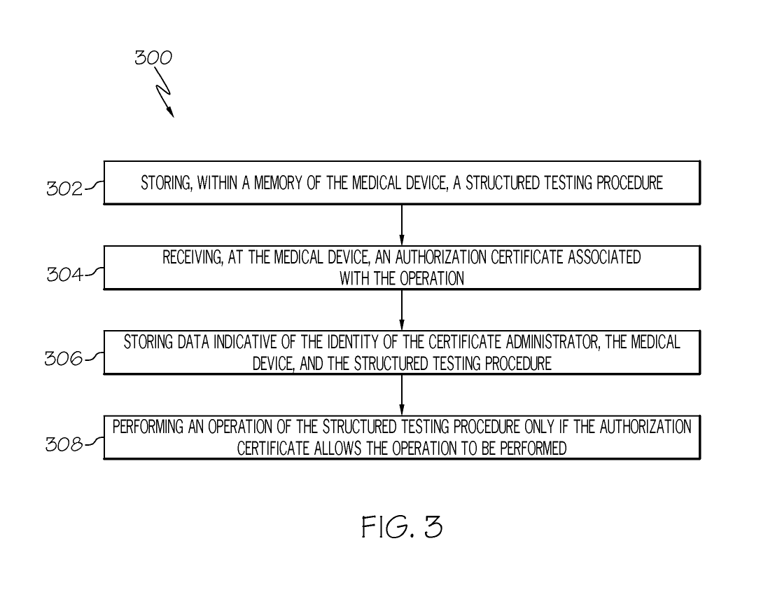

Referring now to FIGS. 2 and 3, method 300 for authorizing access to a medical device is shown, according to an exemplary embodiment. Method 300 includes storing, within a memory of the medical device, a structured testing procedure (block 302). For example, as shown in FIG. 2, processor 105 of collection device 24 stores one or more structured testing procedures as part of configurations 70 in memory 107 and/or on computer readable medium 40. When the processor 105 of collection device 24 reads the structured testing procedures directly from computer-readable medium 40 or from a remote location via network 50, these may also be considered as being extensions of memory 107. For example, processor 105 may execute software 34 from clinician computer 25 remotely via network 50 using configurations 70 stored on a local computer readable medium 40. In such a case, the storage locations of software 34 and configurations 70 may also be considered as extensions of memory 107.

Software 34, security settings 71, and configurations 70 (e.g., structured testing procedures 70a, 70b, software updates 70c, and settings 70d) may be preloaded in memory 107, or provided to collection device 24 either automatically from a remote computer (e.g., clinician computer 25, manufacturer server 63, etc.), or in response to a request first received by the remote computer. For example, structured testing procedure 74a may be preloaded in memory 107 by manufacturer 63. Structured testing procedure 74b may be loaded at a later date into memory 107 in response to a request received at computer 25 by clinician 14.

Method 300 is further shown to include receiving, at the collection device, an authorization certificate associated with the operation (block 304). The certificate administrator may be clinician 14, a technician for manufacturer 60, or any other user having authority, or delegated authority, to change the functions of collection device 24. In some embodiments, manufacturer 60 may assign or delegate the authority to change the functions of collection device 24 to clinician 14, only after first verifying the identity of clinician 14. By way of example, clinician 14 may determine that patient 12 should use structured testing procedure 70b and not testing procedure 70a. Clinician 14 may then use computer 25 to provide one or more authorization certificates to collection device 24 associated with structured testing procedure 70b. The one or more authorization certificates may allow patient 12 via interfaces 106 to start testing procedure 70b, stop testing procedure 70b while running, restart testing procedure 70b a specified number of times, run testing procedure 70b for up to a maximum single usage amount of time, and/or allow access to testing procedure 70b, including restarts, for up to a maximum total length of time. In this way, clinician 14 may tailor the functions of collection device 24 via computer 25 to suit the needs of patient 12, while preventing patient 14 (or another unauthorized user) from changing these functions via interfaces 106.

Method 300 is further shown to include storing data indicative of the identity of the certificate administrator, the medical device, and the structured testing procedure (block 306). The data may be stored in the memory of computer 25, collection device 24. For example, in some embodiments, the data may be stored collectively, or independently, on collection device 24, computer 25, or server 63, whenever a certificate administrator adds or removes an authorization certificate from collection device 24. This information tracks not only who has authorized a change in the functionality of collection device 24, but also the current state of collection device 24 (e.g., what versions of software have been installed, what testing procedures have been authorized to run, etc., or any other change to the functions of the device).

Method 300 is also shown to include performing an operation of the structured testing procedure only if the authorization certificate allows the operation to be performed (block 308). In some embodiments, security settings 71 may include one or more authorization certificates that allow or prevent changes to the various functions of collection device 24. Security settings 71 may also prevent unauthorized changes (i.e., received via interfaces 106) to configurations 70 or to software 34 used by the processor 105 of collection device 24. For example, security settings 71 may include one or more authorization certificates that prevent a request from patient 14 received via interfaces 106 from updating the firmware, operating system, or applications on collection device 24. Other certificates may also be used to allow clinician computer 25 to initiate such changes to collection device 24 using a request received via interfaces 106.

When the security settings 71 contain authorization certificates associated with configurations 70, they may be used to prevent or allow an operation of structured testing procedures 70a, 70b to be executed by processor 105. An operation of a structured testing procedure may be, but not limited to, having processor 105 start, stop, or run any part of the testing procedure. For example, one or more authorization certificates in security settings 71 may allow patient 12 to execute particular ones of the structured testing procedures, e.g., 70a while preventing access to other ones of the structured testing procedures, e.g., 70b. In some embodiments, multiple testing procedures 70a, 70b, and/or software versions of software 34 may be stored in memory 107 and the authorization certificates in security settings 71 may prevent processor 105 of collection device 24 from displaying these routines on display 104 or may cause processor 105 to provide indicia on display 104 that patient 12 is unauthorized to access the unauthorized ones of procedures 70b (e.g., as a grayed out menu entry, an icon having an ‘X’ symbol on it, etc.).

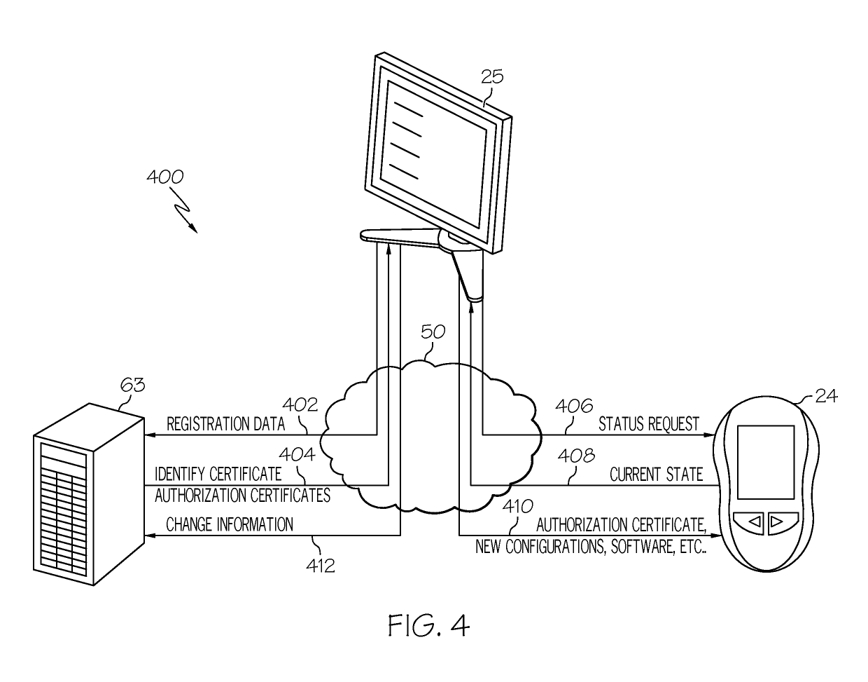

Referring now to FIG. 4, method 400 for using authorization certificates to control access to a medical device is shown, according to an exemplary embodiment. Method 400 includes providing registration data from clinician computer 25 to server 63 of device manufacturer 60 via network 50, as part of a registration process (block 402). The registration process will typically be conducted in advance of clinician 14 meeting with patient 12, but may optionally be conducted while patient 12 waits for the registration process to complete. The registration data sent by computer 25 may include the serial number of the software running on computer 25, the name of the clinician 14 using computer 25 to request a change to collection device 24, or other information that may be used by manufacturer 60 to validate the identity of the clinician 14. Computer 25 may also generate a certificate that has a public and private key and send the certificate to server 63 for signature as part of the registration data. In some embodiments, manufacturer 60 may require additional information to be sent by the requesting clinician 14 outside of network 50 (e.g., via facsimile, postal mail, telephone, or any other way of communicating). For example, the requesting clinician 14 may be required by manufacturer 60 to read a code physically attached to packaging of the software running on computer 25 as part of the verification process, to ensure that the clinician 14 has a valid license to use the software.

In some embodiments, at the time of registration or sometime after, the clinician 14 may use computer 25 to also register one or more medical devices (e.g., collection device 24, therapy devices 42, etc.) with the manufacturer 60. In this case, the registration data sent by computer 25 to server 63 may also include identification information for the medical device (e.g., a serial number or other unique identifier for the device).

Once the identity of the requesting clinician has been validated by the manufacturer, server 63 provides an identity certificate to computer 25 (block 404). In some embodiments, the identity certificate may be part of a public key infrastructure and may be a digitally signed copy of a certificate sent by computer 25 as part of the registration process. In this case, the manufacturer server 63 acts as a certification authority thereby validating the identity of clinician 14 by signing the certificate sent from computer 25 as part of the registration data. The issued identity certificate may also include an expiration date for the certificate, the type of encryption algorithm used, and other information about the manufacturer 60 issuing the certificate.

In some embodiments, if one or more devices are also registered with the manufacturer 60, server 63 may also provide one or more authorization certificates to computer 25 associated with a particular medical device. For example, server 63 may delegate one or more authorization certificates to computer 25 that allow the clinician 14 using computer 25 to change the software, configuration, or settings of collection device 24. In other embodiments, a general authorization certificate is delegated to computer 25 that allows clinician 14 to change the software, configuration, or settings of any associated medical device.

After the registration process is complete, the clinician 14 may utilize computer 25 to select an appropriate testing procedure for the patient 12 and configure the test with additional parameters and authorizations. For example, the structured testing procedure may be an insulin to carbohydrate (“I2C”) optimization procedure. In such a procedure, the clinician 14 may utilize computer 25 to provide parameters for the test such as a starting ratio, maximum ratio, minimum ratio, a target meal, a start date, a start time, and other parameters associated with the selected structured testing procedure. The clinician may also utilize computer 25 to provide authorizations associated with the testing procedure itself, such as the authorization to exit a running test, restarting a test, re-running a test, a maximum number of times a test can be restarted, a maximum time limit that a test may run, a maximum total time limit for all tests, or any other authorization associated with the starting, running, and stopping of the selected testing procedure on collection device 24.

Method 400 also includes providing a status request to the medical device, to determine the current state of the device (e.g., the software, configurations, testing procedures, parameters, and other data that control the functions of the device) (block 406). For example, computer 25 may send a status request query to the processor 105 of collection device 24 via network 50. The status request may be sent by computer 25 at any time relative to the selection of the testing procedure and configuration of the procedure by the clinician 14. For example, the status request may be sent by computer 82 upon initializing a configuration program on computer 25 associated with collection device 24. In another example, the status request may be sent only after computer 25 receives a synchronization request from clinician 14, e.g., via interface 86. In an alternative embodiment, the processor 105 of collection device 24 is configured by program instructions to automatically provide status information to computer 25 without receiving a status request via interfaces 106.

In response to receiving a status request, the processor 105 of collection device 24 provides current state data indicative of its current state to the requesting device (block 408). For example, collection device 24 may provide data indicative of the software, configurations, and authorizations currently installed on collection device 24 to computer 25 via network 50. In other embodiments, processor 105 of collection device 24 may automatically provide the state data to computer 25 without first receiving a status request. For example, processor 105 of collection device 24 may provide the state data to computer 25 periodically, upon establishing a connection with computer 25, or in response to receiving a request to provide the state data from a user of collection device 24. In further embodiments, the current state of the device information may also include information about one or more authorization certificates already on collection device 24.

Computer 25 compares the state data received from the medical device and the selected testing procedure and configurations from the clinician 14 to determine if any changes need to be made to the functions of the medical device. For example, computer 25 may determine that no changes need to be made, if the state of collection device 24 (e.g., the software, configurations, security, etc., on the device) match the state requested by the clinician 14. If computer 25 determines that changes need to be made, computer 25 may also determine which authorizations, testing procedures, and software are necessary to implement the state requested by the clinician 14 on collection device 24. For example, computer 25 may determine that collection device 24 requires a firmware update before it can execute the structured testing procedure requested by the clinician. If any of the software, configurations, security, etc. are not locally present on computer 25, computer 25 may also retrieve them from a remote computer, such as server 63. For example, if the testing procedure specified by clinician 14 is not present on computer 25, the testing procedure may be downloaded from server 63. Computer 25 may also determine that one or more testing procedures, software applications, or parameters on collection device 24 are obsolete or no longer needed by the patient 12. In embodiments where the state data also includes authorization information, computer 25 may use this information to determine if a state change is even authorized to be transferred to collection device 24. For example, collection device 24 may store an authorization certificate that allows only certain testing procedures to be transferred to it. In this way, authorization certificates may even be used to prevent the downloading of a state change to collection device 24 entirely.

Method 400 is further shown to include providing an authorization certificate, new configurations, software changes, and other state change data to the medical device (block 410). After computer 25 determines that a state change is needed for collection device 24, computer 25 provides the new state data to collection device 24 via network 50. If computer 25 determines that a procedure, software, or parameters are obsolete, the state change data may include a request from computer 25 to uninstall the procedure, software, etc., or to remove the authorizations associated with them from collection device 24. If computer 25 determines that a firmware update is needed, the state change data may also include the updated firmware. In this way, computer 25 causes the state of collection device 24 to match the state requested by the clinician.

In some embodiments, qualification tests may be performed after the configurations, software changes, and other state changes are provided to the medical device, but prior to the authorization certificate being provided. For example, computer 25 may perform one or more installation qualification (IQ) routines to determine if the software, testing protocols, etc., have been installed properly on collection device 24. This may include, but is not limited to, computer 25 or collection device 24 utilizing checksums to verify that the data has been transferred correctly. This may also include computer 25 and/or collection device 24 verifying that a structured testing procedure is recognized by collection device 24.

Computer 25 may also perform one or more operation qualification (OQ) routines, prior to providing the authorization certificate to collection device 24. Operation qualification routines verify that the installed software, configuration, etc. on collection device 24 are operating properly. This may include, but is not limited, to: evaluating the free storage on collection device 24 (e.g., is there enough free memory to collect information during a test?), evaluating the processing capabilities of collection device 24 (e.g., does it support the necessary function which, when run, produce a previously calculated result), and evaluating the display capabilities of collection device 24 (e.g., is the display system of collection device 24 capable of displaying the messages and/or graphics required by a transferred structured test). Once the IQ and/or OQ routines have been performed, computer 25 may then transfer the appropriate authorization certificate to collection device 24 to allow the patient to access the transferred structured testing procedures.

In another embodiment, the authorization certificate itself may include information pertaining to the expected results of the successful completion of one or more IQ and/or OQ routines. The collection device 24 or the computer 25 may perform one or more IQ and/or OQ routines and then compare the results with the expected results contained in the authorization certificate. If the actual results match the expected results contained in the authorization certificate, the collection device 24 will pass the one or more IQ and/or OQ routines.

In some embodiments, computer 25 may use the identity certificate issued by server 63 to digitally sign the software, testing procedures, configurations, etc., that are sent to collection device 24 as part of the state change data. Computer 25 does so by generating a public-private key pair and signing the state change data using the identity certificate and the private key. For example, computer 25 may generate a key pair using the following information:
1. The serial number of the configuration software on computer 25.
2. The serial number of collection device 24.
3. A checksum of the structured test executable (e.g., software) to be installed on collection device 24.
4. A checksum of the structured test configuration file (e.g., configurations) to be installed on collection device 24.
   Such a key pair provides security over the state data to ensure that the state change data transferred to collection device 24 matches the state change data originating from clinician computer 25. This helps to prevent unauthorized users (e.g., those not verified by manufacturer 60) from altering the state of collection device 24. Computer 25 may digitally sign the state change data using any known digital signature technique. For example, computer 25 may utilize a hash function on the state change data and encrypt the hashed data with the generated private key to form a digital signature. Computer 25 may then attach its identity certificate and the generated digital signature to the state change data.

The processor 105 of collection device 24 may utilize the digitally signed state change data and the public key generated by computer 25 to verify that the received state change data actually originated from computer 25. The processor 105 of collection device 24 may do so by hashing the state change data and decrypting the digital signature using the public key from computer 25. If the processor 105 determines that resulting hashes match, processor 105 accepts the state change data as verified. If they do not match, the processor 105 of collection device 24 may take countermeasures such as preventing the installation of the state change data, providing a security notification to a remote computer (e.g., clinician computer 25, device manufacturer server 63, etc.), providing a user notification to display 104, or preventing the source of the received data from accessing collection device 24 over network 50.

In some embodiments, computer 25 may also generate an authorization certificate with a pointer to the state change data, such as a configuration file, an executable software program, or other files in the state change data. For example, computer 25 may use the key pair generated to sign the state change data to create a custom authorization certificate. The created authorization certificate may include a delegation chain (e.g., signatures from manufacturer server 63, clinician computer 25, etc.) that allow the processor 105 of collection device 24 to verify that proper authorizations have been given to run the state change data. The processor 105 of collection device 24 may first verify the validity of the authorization certificate before using the pointer to the associated software program and/or configuration file to run the testing procedure. In this way, information in a configuration file may be protected from unauthorized changes. For example, protected information may include:
1. The name or other identifier of the patient.
2. The name of the structured testing procedure.
3. The unique identification number of the testing procedure.
4. The version of the structured testing procedure.
5. Visibility parameters that control whether or not a function is displayed to a user, is displayed but not accessible (e.g., appears as grayed out, etc.), or is not displayed at all.
6. A parameter that controls whether the patient can abort the testing procedure.
7. A parameter that controls whether the patient can restart the testing procedure.
8. A parameter that control whether the patient can re-run the testing procedure.
9. A parameter that defines a maximum number of times the testing procedure can be restarted.
10. A parameter that defines a maximum number of times the testing procedure can be rerun.
11. A parameter that defines a maximum length of times a single instance of the testing procedure can run.
12. A parameter that defines a maximum total length of time that multiple instances of the testing procedure can run.
   Collection device 24 may utilize the protected information in the configuration file to control the patient's access to the functions of collection device 24. If an authorization certificate is not present on collection device 24, or if collection device 24 determines that a delegation chain for an authorization certificate is not valid, collection device 24 may prevent access to the associated functions.

Method 400 finally includes providing recorded information about the requested state change to the manufacturer (block 412). The information about the state change may include the name of the requesting clinician, a timestamp indicative of when the clinician 14 provided the state change request to computer 25, a timestamp indicative of when the state change data was provided to collection device 24, the name of the patient 12, the serial number of the application running on computer 25, the serial number of collection device 24, the name of the testing procedure, protected information related to the permissions given to the patient 12 (e.g., the ability to abort a testing procedure, the ability to restart a testing procedure, etc.), errors associated with the state change process, and any other information related to the setup of collection device 24 for the patient. In other embodiments, computer 25 may store this information locally or provide the information to collection device 24 or other computing systems connected via network 50, such as patient computer 18.

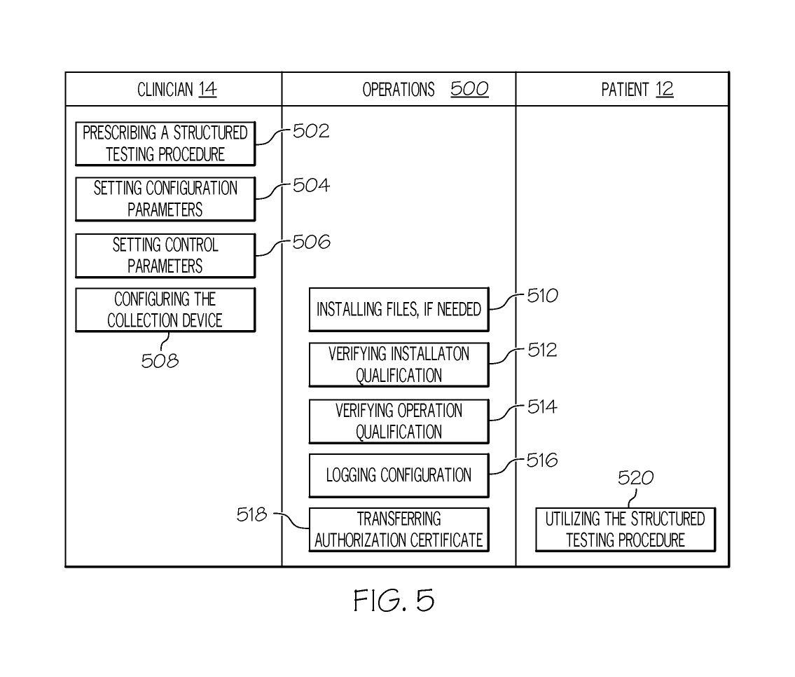

Referring now to FIG. 5, various interactions among clinician 14, patient 12, and operations 500 of selected embodiments for authorizing a structured testing procedure on a collection device are shown. The various interactions can occur in a clinical setting, such as the clinician's office, or in a patient setting, such as the patient's home. The operations 500 can be performed on a personal computer (e.g., computer 25, etc.), a server (e.g., server 53, etc.), or on a collection device (e.g., collection device 24) communicating via a network.

At 502, clinician 14 determines that a structured testing procedure is needed and prescribes the structured testing procedure to patient 12. For example, patient 14 may be a Type 2 diabetic on oral anti-diabetic agents (OADs) that presents symptoms of elevated fasting blood glucose values. Clinician 14 may prescribe long acting insulin as a supplement to the OADs. However, clinician 14 must still determine the correct dosage of insulin required by patient 12. Clinician 14 prescribes a structured testing procedure, in order to collect information relevant to this determination.

At 504, clinician 14 sets the configuration parameters for the prescribed structured testing procedure. In general, the configuration parameters affect how the structured testing procedure is performed. For example, configuration parameters may include, but are not limited to, starting dosage, maximum dosage, titration strategy, exit strategy, adherence criteria, and acceptance parameters for the structured testing procedure.

At 506, clinician 14 also sets the control parameters for the prescribed structured testing procedure. In general, the control parameters determine when the structured testing procedure can be run and for how long. For example, control parameters may include, but are not limited, when the structured testing procedure can be started, whether it can be restarted by patient 12 if the test does not complete, whether it can be re-run by patient 12, the maximum time a single instance can be run, etc.

At 508, clinician 14 initiates the configuration of the collection device that is to perform the structured testing procedure. In some embodiments, the configuration may be performed in real time or near real-time. For example, the collection device may be configured while patient 12 is at the office of clinician 14 or may be performed remotely while patient 12 and the collection device are at a remote location. In other embodiments, the configuration may be automatically performed at a later time. For example, clinician 14 may first initiate the configuration of the collection device. At a later time, patient 12 may remotely connect the collection device to the computer of clinician 14, in order to complete the configuration process.

Operations 500 are performed, in order to configure the collection device to run the prescribed structured testing procedure. At 510, a determination is made as to whether files need to be uploaded to the collection device. For example, the collection device may have one or more structured testing procedures already loaded, either by the device's manufacturer, or from a previously prescribed testing procedure. Also at 510, if one or more files are determined to be needed, the files are also installed to the collection device. For example, the control parameters configuration parameters may also be installed to the collection device at this time.

At 512, if a structured testing procedure is installed as part of the configuration process, an installation qualification is performed. The installation qualification verifies that the structured testing procedure is installed correctly. For example, this may include verifying that all of the necessary files for the structured test are present on the collection device (e.g., by verifying their checksums, etc.). This may also include a verification that the control system of the collection device recognizes the installed structured testing procedure properly.

At 514, if a structured testing procedure is installed as part of the configuration process, an operation qualification may also be performed. An operation qualification verifies that the installed structured testing procedure is operating properly. This may include, but is not limited to, analyzing the free memory space of the collection device, evaluating the processing capabilities of the collection device, and analyzing the display capabilities of the collection device.

At 516, information about the configuration change is logged to one or more computer systems. For example, the identity of prescribing clinician 14, the prescribed structured testing procedure and device configuration, and the identity of the collection device may be stored in one or more of the clinician's computer, the patient's computer, the collection device itself, the device manufacturer's server, and/or other servers in the healthcare network. Additional information, such as timestamp information, may also be stored at this time. This information may be used, for example, to provide traceability for another clinician if patient 12 later switches doctors.

At 518, one or more authorization certificates associated with the structured testing procedure, the configuration parameters, and the control parameters are transferred to the collection device. If the installation qualification, operation qualification, or the logging functions determine that a problem exists (e.g., files have not been transferred correctly, the collection device cannot properly run the testing procedure, etc.), no authorizations may be transferred and a message may be sent to clinician 14 and/or to patient 12 alerting them to the failure.

At 520, if the collection device passes the qualifications, the configuration change is properly recorded, and if the proper authorizations are transferred, patient 12 may utilize the structured testing procedure on the collection device. The structured testing procedure thereby collects the required measurements to allow clinician 14 to better evaluate how patient 12 reacts to changes over time and to prescribe one or more medicaments accordingly.

Referring now again to FIG. 1, the security protocols and techniques described thus far may be extended to provide authorization control and state change tracking for chronic care management system 10. In one embodiment, patient 12 may utilize patient computer 18 to register their identity with manufacturer 60. Manufacturer server 63 may then provide an identity certificate and authorizations to patient computer 18. The authorizations delegated to patient computer 18 and to clinician computer 25 may differ, thereby granting patient 12 less privileges to change the state of collection device 24 than clinician 14. For example, patient 12 may be authorized to update the firmware of collection device 24, but not be authorized to change the accessible testing procedures or configurations set by clinician 14. This allows patient 12 to install critical updates and other important updates from manufacturer 60 without having to first contact clinician 14, while still ensuring that collection device 24 functions as prescribed by clinician 14. Similarly, collection device 24 may record and store the state change information or provide the information to another computing device via network 50.

In some embodiments, clinician computer 25 may also provide authorizations for other medical devices, such as ambulatory infusion pump 46. For example, if a particular testing procedure has been authorized by clinician 14 to run on collection device 24, patient 12 may use patient computer 18 to install corresponding authorized updates onto ambulatory infusion pump 46. Similarly, clinician 14 may use computer 25 to authorize ambulatory infusion pump 46 to perform one or more functions. In this way, clinician 14 may control authorizations associated with any number of medical devices related to the authorization of collection device 24.

Thus, by the above disclosure embodiments concerning a system and method for managing the security and authorizations associated with a medical device are disclosed. One skilled in the art will appreciate that the teachings can be practiced with embodiments other than those disclosed. The disclosed embodiments are presented for purposes of illustration and not limitation, and the invention is only limited by the claims that follow. For example, the methods and systems described here are not limited to any particular hardware or software configuration, or to any particular communications modality, but rather they may find applicability in any communications or computer network environment.

Many modifications and variations of embodiments of the present invention are possible in light of the above description. The above-described embodiments of the various systems may be used alone or in any combination thereof without departing from the scope of the invention. Although the description and figures may show a specific ordering of steps, it is to be understood that different orderings of the steps are also contemplated in the present disclosure. Likewise, one or more steps may be performed concurrently or partially concurrently.

What is claimed is:

1. A method for authorizing access to a medical device, the method comprising:
storing, within a memory of the medical device, a structured testing procedure;
receiving, at an interface of the medical device, the authorization certificate associated with the operation in response to a request received from a user interface device operated by a certificate administrator;
storing data indicative of the identity of the certificate administrator, the medical device, and the structured testing procedure; and
executing program instructions within a processor of the medical device to perform an operation of the structured testing procedure only if the authorization certificate allows the operation to be performed.

2. The method of claim 1, wherein the authorization certificate allows the structured testing procedure to be started or restarted.

3. The method of claim 1, wherein the method further comprises:
performing at least one of an installation qualification routine and operation qualification routine prior to receiving the authorization certificate.

4. The method of claim 1, wherein the authorization certificate allows the structured testing procedure to be stopped in response to the medical device receiving a stop command from a user interface.

5. The method of claim 1, wherein the authorization certificate allows the structured testing procedure to run up to a maximum amount of time.

6. The method of claim 1, wherein the authorization certificate allows the structured testing procedure to run, so long as a cumulative runtime parameter of the structured testing procedure is below a specified threshold.

7. The method of claim 1, wherein the authorization certificate allows a specific version of the structured testing procedure to run.

8. A collection device comprising:
a display;
a memory;
a processor operably connected to the memory and the display; and
program instructions when executed by the processor cause the processor to:
determine if an authorization certificate associated with an operation of a structured testing procedure allows the operation to be performed;
perform an operation of a structured testing procedure based on the determination;
receive the authorization certificate in response to a request from a certificate administrator; and
cause data indicative of the identity of the certificate administrator, the glucose meter, and the structured testing procedure to be stored.

9. The collection device of claim 8, wherein the authorization certificate allows the structured testing procedure to be started in response to the processor receiving a start command from a user interface.

10. The collection device of claim 8, wherein the authorization certificate allows the structured testing procedure to be restarted in response to the processor receiving a restart command from a user interface.

11. The collection device of claim 8, wherein the authorization certificate allows the structured testing procedure to be stopped in response to the processor receiving a stop command from a user interface.

12. The collection device of claim 8, wherein the authorization certificate allows the structured testing procedure to run up to a maximum amount of time.

13. The collection device of claim 8, wherein the authorization certificate allows the structured testing procedure to run, so long as a cumulative runtime parameter of the structured testing procedure is below a specified threshold.

14. A system for determining a dosage of a medicament comprising:
a collection device that determines the dosage using a structured testing procedure, wherein an operation of the structured testing procedure is performed only if an authorization certificate associated with the testing procedure allows the operation to be performed; and
a certificate administration computing device that provides the authorization certificate to the collection device in response to receiving a request from a certificate administrator, wherein the certificate administration computing device further stores data indicative of the identity of the certificate administrator, the collection device, and the structured testing procedure.

15. The system of claim 14, wherein the collection device stores a configuration change authorization certificate, and wherein the certificate administration computing device causes a structured testing procedure to be transferred to the collection device only if the configuration change authorization certificate allows the transfer.

16. The system of claim 14, wherein the authorization certificate allows the structured testing procedure to be restarted.

17. The system of claim 14, wherein the authorization certificate allows the structured testing procedure to be stopped.

18. The system of claim 14, wherein the authorization certificate allows the structured testing procedure to run up to a maximum amount of time.

19. The system of claim 14, wherein the authorization certificate allows the structured testing procedure to run, so long as a cumulative runtime parameter of the structured testing procedure is below a specified threshold.

20. The system of claim 14, further comprising a second authorization certificate that allows the firmware of the collection device to be updated.

21. A method of authorizing a structured testing procedure, comprising:
providing a collection device according to claim 8; and
authorizing a function of the collection device utilizing an authorization certificate.
